(19) United States
(12) Patent Application Publication
(10) Pub. No.: US 2012/0312282 A1
(43) Pub. Date: Dec. 13, 2012

(54) PRESSURE-WAVE SUPERCHARGER, AND METHOD OF OPERATING A PRESSURE-WAVE SUPERCHARGER

(75) Inventors: GEORG GLITZ, Paderborn (DE); JAN ARASZKIEWICZ, Neuenbeken (DE)

(73) Assignee: Benteler Automobiltechnik GmbH, Paderborn (DE)

(21) Appl. No.: 13/324,290

(22) Filed: Dec. 13, 2011

(30) Foreign Application Priority Data
Dec. 14, 2010 (DE) 10 2010 054 505.8

(51) Int. Cl. F02B 33/00

(52) U.S. Cl. 123/559.2; 123/559.1

(57) ABSTRACT

A pressure-wave supercharger for a combustion engine of a motor vehicle includes a first channel for drawing fresh air, a second channel for discharging compressed fresh air, a third channel for supply of exhaust gas, and a fourth channel for discharging exhaust gas. A hot-gas housing receives exhaust from the third channel for discharge through the fourth channel, and a cold-gas housing receives fresh air from the first channel and discharges compressed fresh air through the second channel. Disposed between the hot-gas housing and the cold-gas housing is a cell rotor housing which has a cell rotor. A guide element is arranged in at least one of the first and third channels to guide a gas flow for accelerating or decelerating the cell rotor.

### CROSS-REFERENCES TO RELATED APPLICATIONS

This application claims the priority of German Patent Application, Serial No. 10 2010 054 505.8, filed Dec. 14, 2010, pursuant to 35 U.S.C. 119(a)-(d), the content of which is incorporated herein by reference in its entirety as if fully set forth herein.

### BACKGROUND OF THE INVENTION

The present invention relates to a pressure-wave supercharger for a combustion engine of a motor vehicle, and to a method of operating a pressure-wave supercharger.

The following discussion of related art is provided to assist the reader in understanding the advantages of the invention, and is not to be construed as an admission that this related art is prior art to this invention.

Combustion engines use components suitable for compressing aspirated fresh air for subsequent supply to the combustion process in order to increase the performance of the combustion engine. These components or machines are known as supercharger systems and utilize various physical effects to carry out the afore-mentioned process.

A possibility to charge the combustion engine through compression of the aspirated fresh air is the use of a pressure-wave supercharger. The efficiency of the pressure-wave supercharger is determined by the mechanical components and the possibility of adaptive adjustment to the operating state of the engine at hand in the form of a closed-loop control and open-loop control.

The pressure-wave supercharger includes fixed and rotating components. The fixed components includes the housing, the rotor housing which is subdivided in a hot-gas housing and a cold-gas housing, and suitable feed and discharge conduits for conducting the gaseous fluids. The rotating components include the cell rotor and optionally an electric motor to operate the cell rotor.

The use of a pressure-wave supercharger, for example on a combustion engine in the automobile field, has to meet stringent demands with respect to operating conditions and service life. There are situations that require a reliable operation of the pressure-wave supercharger over a service life of several years at −20° C. and +50° C. outside temperature. Exhaust temperatures of 900° C. and more also adversely affect the longevity and reliability of operation of the pressure-wave supercharger.

The operating behavior of conventional pressure-wave superchargers, in particular when used in exhaust systems, is greatly depended on the pressure ratio between the intake channel for fresh air and the outlet channel of the exhaust. The reason for that resides in the fact that the cell rotor is not sufficiently scavenged to ensure an optimal operation of the pressure-wave supercharger. The cell rotor is therefore never optimally filled during operation. The resultant pressure loss is determined by the intake system and exhaust system of the engine. When the pressure-wave supercharger operates in a range with maximum mass flow rate, the rising pressure loss of the exhaust system limits a further increase in throughput.

The attainable efficiency of a pressure-wave supercharger thus depends directly on the attainable, minimal gap sizes between the gas-filled components and the power output to be generated by an electric motor which conforms the rotation speed of the cell rotor to the charge pressure and the demand of mass flow rate of the combustion engine. The substantial acceleration energy to be generated by the electric motor to operate the cell rotor adversely affects efficiency of a pressure-wave supercharger, in particular when transient operations are involved.

The pressure-wave superchargers are configured as turbo engines for certain mass flows and/or flow rates. When the level in which the pressure-wave supercharger operates at high efficiency is exceeded, the electric motor coupled with the cell rotor can be used as generator. This is primarily the case when operating at high rotation speeds in which the effective moment of the electric motor is available only to limited degree so that the residual energy contained in the exhaust cannot be utilized in an optimum manner.

It would therefore be desirable and advantageous to provide an improved pressure-wave supercharger to obviate prior art shortcomings and to operate over a broad operating spectrum at optimal efficiency.

### SUMMARY OF THE INVENTION

According to one aspect of the present invention, a pressure-wave supercharger for a combustion engine of a motor vehicle includes a first channel for drawing fresh air, a second channel for discharging compressed fresh air, a third channel for supply of exhaust gas, a fourth channel for discharging exhaust gas, a hot-gas housing receiving exhaust from the third channel for discharge through the fourth channel, a cold-gas housing receiving fresh air from the first channel and discharging compressed fresh air through the second channel, a cell rotor housing disposed between the hot-gas housing and the cold-gas housing and having a cell rotor, and a guide element arranged in at least one of the first and third channels to guide a gas flow for accelerating or decelerating the cell rotor.

The first channel and/or the third channel are not to be considered within the scope of the present invention materially as a single pipeline. Rather the first channel and/or the third channel can include as additional part a respective section in the hot-gas housing or cold-gas housing or intermediate elements coupled between the pipelines and the hot-gas housing.

The provision of the guide element enables incoming fresh air or incoming exhaust to be directed in gas-dynamic manner so as to assist the electric motor which operates the cell rotor. For example, when operating in the low-speed range, the gas flow can be routed by the guide element in a way as to establish a simple acceleration of the cell rotor with the assistance of the guide element so that a potential electric drive motor requires only slight acceleration work. When operating at high speed and low load, the guide element can be configured to decelerate the cell rotor so that an electric motor which has been coupled to the pressure-wave supercharger can operate at optimal efficiency.

According to another advantageous feature of the present invention, the guide element can be arranged in the first channel in an entry region of the cell rotor to conduct aspirated fresh air into the cell rotor. The guide element can be arranged in the pipeline of the first channel or in the entry region, i.e. in the passage of the cold-gas housing forming the first channel. Currently preferred is the disposition in the entry region because a targeted deflection of the gas flow has a direct impact on the flow of aspirated fresh air to the cells of the cell rotor. This is especially advantageous for an acceleration behavior of the cell rotor.

According to another advantageous feature of the present invention, the guide element can be arranged in the third channel in an entry region of the cell rotor to conduct exhaust gas into the cell rotor. This provides the same benefits as described above with respect to the first channel. In addition, the guide element in the third channel is constructed to be resistant to high temperature of the exhausts which may range to up to several 100° C.

According to another advantageous feature of the present invention, the guide element can be adjustably supported. The adjustment is primarily realized by allowing the guide element to swing about a pivot axis. Of course, the guide element may, for example, also be slideably supported or adjustable in any other appropriate manner. The adjustment provides the guide element with a broad spectrum of use and thus allows the guide element to assist the pressure-wave supercharger over its entire operating range in an optimal manner.

The guide element may be adjusted for acceleration of the cell rotor such as to allow selection of an angular disposition that enables gas forces to assist the acceleration of the cell rotor. The guide element may be positioned for the stationary and/or mid-operating range of the pressure-wave supercharger in such a way that no flow losses are encountered. In a gas-dynamic sense, the presence of the guide element has the virtual effect as if it does not exist.

In order to decelerate the cell rotor, the guide element can again be adjusted in a way that the gas forces impact the cell rotor through targeted flow conduction to have a braking effect on the cell rotor. Adjustment may be passive so that the guide element spontaneously adjusts itself in response to thermodynamic properties and/or flow rates.

According to another advantageous feature of the present invention, an actuator can be provided for active adjustment of the guide element. Advantageously, the actuator is configured as an electric actuator. The actuator can be operably connected to a closed-loop control and/or open-loop control for positioning the guide element in such a way that aspirated fresh air or exhaust discharged by the combustion engine flows against the cell rotor at a desired angle. Thus, active manipulation is possible to suit the operating behavior at hand and the pressure-wave supercharger can be controlled in an optimum manner so that the pressure-wave supercharger and thus the combustion engine have improved responsiveness. As a result, the efficiency of the pressure-wave supercharger is improved, and consequently that of the combustion engine as well.

According to another advantageous feature of the present invention, the guide element can have at least one guide vane. The guide vane may simply be designed as a baffle plate. Currently preferred is however a configuration of a geometry which optimizes flow conditions. For example, the guide vane may be curved or have separation edges to generate turbulent flows at particular thermodynamic properties or flow rates of the gas. The guide element in the third channel may in particular be configured to be highly temperature-resistant so as to withstand any thermal impact by the exhaust. Of course, the guide element may have two, three or more guide vanes.

When the guide element has two guide vanes, there is the possibility to construct the guide vanes for adjustment independently from one another. For example, it is then possible to provide an acceleration-optimized operation and a deceleration-optimized operation at the same time. This is beneficial in certain operating points of the pressure-wave supercharger. It is also possible within the scope of the invention to control the guide element of the first channel in synchronism with the guide element of the third channel, or to control the guide element of the first channel independently from the guide element of the third channel.

According to another advantageous feature of the present invention, an edge slider may be disposed on a cold-gas side, with the guide element being arranged in the edge slider. The edge slider is provided to control an opening cross sectional area of the first channel and/or second channel. This allows targeted influence of the respective filling of the cells. The control of the edge slider can hereby be combined with the adjustment option of the guide element in the first channel, which advantageously is integrated in the edge slider. Suitably, the guide element can be adjusted in synchronism with the edge slider to eliminate any problems associated with coordination of the edge slider and guide element during closed-loop control and open-loop control. Furthermore, susceptibility to malfunction and production costs are reduced because there is need for only one actuator for simultaneously adjusting the edge slider and the guide element. The guide element in the third channel may also be operably connected to this actuator.

According to another aspect of the present invention, a method of operating a pressure-wave supercharger for a combustion engine includes controlling a guide element in dependence on an operating state of the pressure-wave supercharger for optionally accelerating or decelerating a cell rotor. Advantageously, the guide element can be actively adjustable, with the operating state of the pressure-wave supercharger being analyzed and the guide element in the first channel and/or third channel respectively controlled.

Determination of the operating state of the pressure-wave supercharger is realized in accordance with the present invention in response to operating parameters which are measured at the combustion engine and allow inference to the operating state of the pressure-wave supercharger with reference to a characteristic diagram conversion.

According to another advantageous feature of the present invention, the guide element can be controlled, using open-loop control and/or closed-loop control. The control may hereby take place using the desired operating state of the pressure-wave supercharger. In other words, the operating parameters of the combustion engine and the parameters of the operator of a motor vehicle, for example accelerator-pedal position, provide an indication about the output of the pressure-wave charger that needs to be generated. To attain this output, the pressure-wave supercharger is pre-set. This has a beneficial effect on the attained acceleration dynamics of the combustion engine that is coupled to the pressure-wave supercharger.

According to another advantageous feature of the present invention, the guide element can be adjusted to an acceleration position when the combustion engine is subject to a load increase and/or rotation speed increase. The energy contained in the aspirated fresh air or in the exhaust is used for accelerating the cell rotor. When an electric motor is connected to the pressure-wave supercharger, in particular in light of a need for reduction of CO₂ emission, the energy contained in the gas flow is converted into electric energy so that the supply of the on-board electrical system and/or charging of the vehicle battery is accompanied by a relief of the primary generator. This increases efficiency of the combustion engine as friction is minimized across the primary generator.

According to another advantageous feature of the present invention, the guide element can be adjusted to a deceleration position when the combustion engine is subject to a load decrease and/or rotation speed decrease. The afore-described elaborations apply here as well. The cell rotor is slowed down in the deceleration position of the guide element so that an electric motor connected to the cell rotor is able to operate at optimal efficiency and prevented from overloading.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of one embodiment of a pressure-wave supercharger according to the present invention;

FIG. 2 is a schematic illustration of another embodiment of a pressure-wave supercharger according to the present invention;

FIG. 3 is a schematic illustration of a pressure-wave supercharger according to the present invention, showing in greater detail fresh air and gas flows into a cell rotor, with guide elements shown in two exemplary channels in their orientation for acceleration of the cell rotor; and

FIG. 4 is a schematic illustration of a pressure-wave supercharger according to the present invention, showing in greater detail fresh air and gas flows into a cell rotor, with guide elements shown in two exemplary channels in their orientation for deceleration of the cell rotor.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

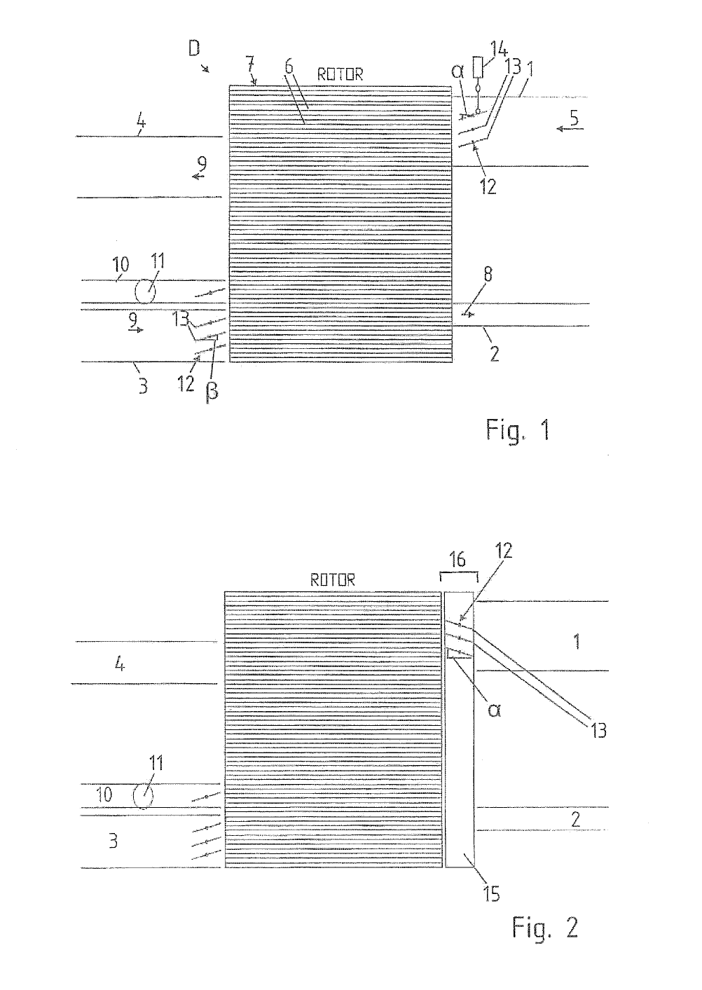

Turning now to the drawing, and in particular to FIG. 1, there is shown a schematic illustration of one embodiment of a pressure-wave supercharger according to the present invention, generally designated by reference symbol D. The pressure-wave supercharger D has a first channel 1, a second channel 2, a third channel 3, and a fourth channel 4. Fresh air 5 flows through the first channel 1 into cells 6 of a cell rotor 7 and is compressed in the cells 6 to exit as compressed fresh air 8 through the second channel 2 and ultimately to a combustion engine, not shown in greater detail. During a charge cycle in the combustion engine, exhaust gas 9 produced by the combustion cycle is released and flows via the third channel 3 and optionally a channel 10 into the cells 6 of the cell rotor 7 to compress fresh air 5 fed into the cells 6 of the cell rotor 7 via the first channel 1. Disposed in the channel 10 is a valve 11 to allow the optional addition of this channel for conduction of exhaust 9. Channel 10 is used in particular for transferring fresh air 5 from the second channel 2. Other functions may also be assumed by the channel 10. The channel 10 may for example be connected to the outlet of the combustion engine. Also, although not shown in the drawing, the valve 11 may be switched to provide a direct connection from channel 3 to channel 4, or to assist the incoming amount of exhaust into the channel 10 so as to allow entry of added exhaust gas into the cell rotor 7. It is also conceivable to conduct fresh air from channel 2 back to the pressure-wave supercharger D via channel 10 while bypassing the combustion engine through opening of valve 11.

After the fresh air 5 has been compressed and discharged through the second channel 2, exhaust gas 9 exits the fourth channel 4 and is fed to an exhaust-gas system. A guide element 12 is arranged in the first channel 1 and another guide element 12 is positioned in the third channel 3. Each guide element 12 includes three guide vanes 13 which can be controlled by an actuator 14 so that the guide element 12 in the first channel 1 can be positioned at an angle α to best suit the situation at hand, and the guide element 12 in the third channel 3 can be positioned at an angle β to best suit the situation at hand. Actuation of the guide elements 12 or guide vanes 13 involves hereby a rotation or pivoting thereof. It will be understood by persons killed in the art that the illustration of three guide vane 13 for each guide element 12 is made by example only. It is, of course, also possible within the scope of the present invention to provide each guide element 12 with a single guide vane 13 which can be pivoted accordingly.

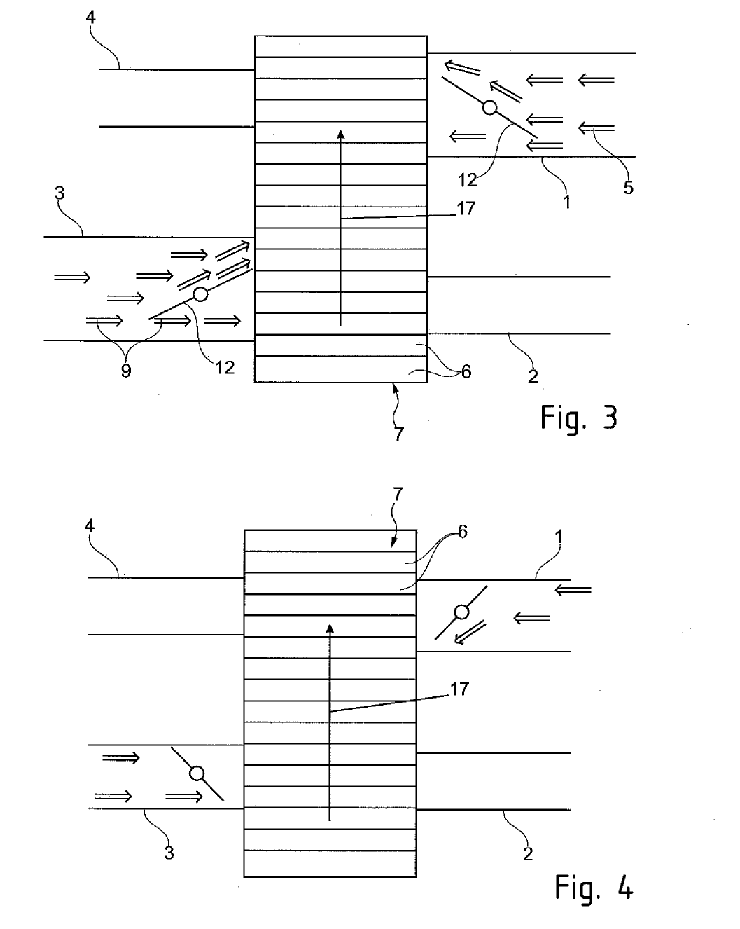

The provision of the guide elements 12 in channels 1 and 3, respectively enables incoming fresh air or incoming exhaust to be directed in gas-dynamic manner so as to assist, if need be, a main drive, e.g. an electric motor, in the operation of the cell rotor 7. As shown by way of example in FIG. 3, the guide elements 12 are positioned in such a way as to attain an acceleration of the cell rotor 7 in its rotation direction 17. FIG. 4 shows a situation in which the guide elements 12 are positioned in the channels 1 and 3 in such a way as to attain a deceleration of the cell rotor 7.

FIG. 2 shows a schematic illustration of another embodiment of a pressure-wave supercharger D according to the present invention. Parts corresponding with those in FIG. 1 are denoted by identical reference numerals and not explained again. The description below will center on the differences between the embodiments. In this embodiment, provision is made for an edge slider 15 which is arranged on the cold-gas housing side, i.e. the side of inflow of fresh air 5 and outflow of compressed fresh air 8. The guide element 12 is arranged in the edge slider 15 and can be positioned at angle α by a control for the edge slider 15 depending on the situation at hand. The edge slider 15 constitutes an adjusting element and can be configured as rotary disk which can be placed upstream or downstream of the pressure-wave supercharger D. Rotation of the edge slider 15 causes an increase or decrease of the cross sectional areas of the various channels, e.g. channels 1 and 2 as shown in the non-limiting example of FIG. 2.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A pressure-wave supercharger for a combustion engine of a motor vehicle, comprising:
a first channel for drawing fresh air;
a second channel for discharging compressed fresh air;
a third channel for supply of exhaust gas;
a fourth channel for discharging exhaust gas;
a hot-gas housing receiving exhaust from the third channel for discharge through the fourth channel;
a cold-gas housing receiving fresh air from the first channel and discharging compressed fresh air through the second channel;
a cell rotor housing disposed between the hot-gas housing and the cold-gas housing and having a cell rotor; and
a guide element arranged in at least one of the first and third channels to guide a gas flow for accelerating or decelerating the cell rotor.

2. The pressure-wave supercharger of claim 1, wherein the guide element is arranged in the first channel in an entry region of the cell rotor to conduct aspirated fresh air into the cell rotor.

3. The pressure-wave supercharger of claim 1, wherein the guide element is arranged in the third channel in an entry region of the cell rotor to conduct exhaust gas into the cell rotor.

4. The pressure-wave supercharger of claim 1, wherein the guide element is adjustably supported.

5. The pressure-wave supercharger of claim 1, further comprising an actuator for adjustment of the guide element.

6. The pressure-wave supercharger of claim 5, wherein the actuator is an electric actuator.

7. The pressure-wave supercharger of claim 1, wherein the guide element has at least one guide vane.

8. The pressure-wave supercharger of claim 1, wherein the guide element has two guide vanes which are constructed for adjustment independently from one another.

9. The pressure-wave supercharger of claim 1, further comprising an edge slider on a cold-gas side, said guide element being arranged in the edge slider.

10. The pressure-wave supercharger of claim 9, wherein the edge slider is constructed to adjust the guide element.

11. A method of operating a pressure-wave supercharger for a combustion engine, comprising controlling a guide element in dependence on an operating state of the pressure-wave supercharger for optionally accelerating or decelerating a cell rotor.

12. The method of claim 11, wherein the controlling step comprises open-loop control or closed-loop control.

13. The method of claim 11, further comprising adjusting the guide element to an acceleration position when the combustion engine is subject to a load increase and/or rotation speed increase.

14. The method of claim 11, further comprising adjusting the guide element to a deceleration position when the combustion engine is subject to a load decrease and/or rotation speed decrease.
